(19) United States
(12) Patent Application Publication
(10) Pub. No.: US 2010/0232530 A1
(43) Pub. Date: Sep. 16, 2010

(54) COMMUNICATION APPARATUS

(75) Inventors: Norikazu EBISAWA, Yokohama (JP); Satoru Abe, Yokohama (JP)

Correspondence Address: ARENT FOX LLP, 1050 CONNECTICUT AVENUE, N.W., SUITE 400, WASHINGTON, DC, 20036, US

(73) Assignee: FUJITSU MICROELECTRONICS LIMITED, Kanagawa (JP)

(21) Appl. No.: 12/717,656

(22) Filed: Mar. 4, 2010

(30) Foreign Application Priority Data
Mar. 11, 2009 (JP) 2009-058541

(51) Int. Cl. H04L 27/28

(52) U.S. Cl. 375/261

(57) ABSTRACT

A communication apparatus includes a transmitter for transmitting an outgoing radio signal, a receiver for receiving an incoming radio signal, and a controller for controlling a direct current carrier leakage, and the transmitter includes a first multiplier for multiplying a first carrier-wave signal by an In-phase signal, a second multiplier for multiplying a signal having the similar frequency as and a phase shifted by 90 degree with respect to the first carrier-wave signal by a Quadrature-phase signal, and a transmitting amplifier for amplifying a composite signal multiplied by the In-phase signal and the Quadrature-phase signal, respectively, and outputting the composite signal for forming the outgoing radio signal.

### CROSS-REFERENCE TO RELATED APPLICATION

This application is based upon and claims the benefit of priority of the prior Japanese Patent Application No. 2009-58541 filed on Mar. 11, 2009, the entire contents of which are incorporated herein by reference.

### FIELD

An aspect of the embodiments discussed herein is directed to a communication apparatus.

### BACKGROUND

An orthogonal frequency division multiplex (OFDM) scheme has been known as a communication scheme. In mobile communication using the OFDM scheme, in some cases, a local oscillator signal that is used in orthogonal modulation performed by an analog transmitter/receiver leaks into a transmission signal in a radio frequency (RF) band. This leakage occurs at the stage of a multiplier of an analog transmitter mainly because of mismatching that is caused by individual differences among analog elements, changes over time, and so forth.

In a wireless communication system, when a carrier leakage is included in a transmission signal, there is a probability that the transmission signal is not satisfied with the maximum allowable radiant energy (a transmit spectrum mask) that is generally indicated. In a case in which the transmission signal is not satisfied with the specification, there is a probability that the transmission signal interferes with other transmission signals and reception signals, and other wireless communication systems.

Furthermore, the following methods are discussed even for a case in which the transmission signal is satisfied with the specification. Japanese National Publication of International Patent Application No. 2006-527530 discusses that the detecting a carrier leakage in a period of time in which a transmission signal is not transmitted to obtain a result. Japanese Laid-open Patent Publication No. 09-83587 discusses the detecting a carrier leakage in a period of time in which a transmission signal is not transmitted to obtain a result and for feeding the result back to a function of reducing a carrier leakage.

Moreover, Japanese Laid-open Patent Publication No. 2000-196561 discusses a method and a receiver for estimating, using a signal in which a frequency offset occurs and which is modulated using the OFDM scheme, the frequency offset with a simple configuration and with a high accuracy.

Additionally, Japanese Laid-open Patent Publication No. 10-322303 discusses a receiver that corrects, when a signal is received, the deviation between a frequency of the signal at the receiver side and a frequency of the signal at the transmitter side of the receiver.

### SUMMARY

According to an aspect of an embodiment, a communication apparatus includes a transmitter for transmitting an outgoing radio signal, a receiver for receiving an incoming radio signal, and a controller for controlling a direct current carrier leakage, wherein the transmitter includes a first multiplier for multiplying a first carrier-wave signal by an In-phase signal, a second multiplier for multiplying a signal having the similar frequency as and a phase shifted by 90 degree with respect to the first carrier-wave signal by a Quadrature-phase signal, and a transmitting amplifier for amplifying a composite signal multiplied by the In-phase signal and the Quadrature-phase signal, respectively, and outputting the composite signal for forming the outgoing radio signal, wherein the receiver includes a receiving amplifier for receiving the income radio signal or the composite signal from the transmitting amplifier, and producing an amplified signal, a third multiplier for producing an In-phase signal by multiplying a second carrier-wave signal by the amplified signal produced by the receiving amplifier, and a fourth multiplier for producing a Quadrature-phase signal by multiplying a signal having the similar frequency as and a phase shifted by 90 degree with respect to the second carrier-wave signal by the amplified signal produced by the receiving amplifier, wherein the controller detects an amount of direct current carrier leakage on a basis of the In-phase signal and Quadrature-phase signal outputted from the receiver when the receiver receives the composite signal from the transmitter, and controls the amount of direct current carrier leakage of the outgoing radio signal from the transmitter in accordance with the detection of the amount of direct current carrier leakage.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a configuration of a communication apparatus according to a first embodiment;

FIGS. 2A-2C indicate diagrams illustrating a case in which a transmission signal is down-converted using a frequency that is shifted from a center frequency of the carrier-wave signal, and in which the transmission signal is demodulated to obtain a frequency spectrum of the transmission signal in a baseband;

FIGS. 3A-3D indicate diagrams illustrating changes in the frequency spectrum of a signal in the communication apparatus illustrated in FIG. 1;

FIG. 4 is a circuit diagram illustrating an example of a detailed configuration of a portion of an analog transmitting circuit;

FIG. 5 is a graph illustrating the relationship between a baseband I signal and DC offset; and

FIG. 6 is a diagram illustrating an example of a configuration of a communication apparatus according to a second embodiment.

### DESCRIPTION OF EMBODIMENTS

As described previously, in a conventional technique, because elements other than a carrier leakage that are included in a multi-carrier signal are detected together, the amount of the carrier leakage may not be accurately detected. Furthermore, a carrier leakage element included in a transmission signal may not be detected when a communication apparatus operates.

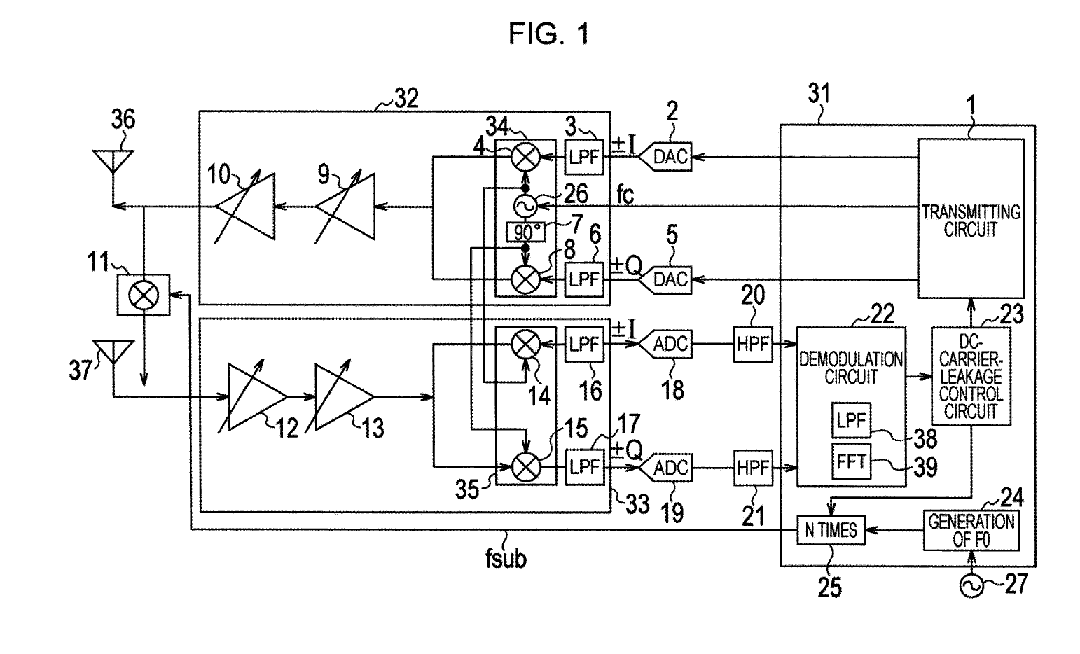

FIG. 1 is a diagram illustrating an example of a configuration of a communication apparatus according to a first embodiment. The communication apparatus is a mobile communication apparatus using the OFDM scheme, and includes a control section 31, digital-to-analog converters 2 and 5, an analog transmitting circuit 32, a transmitting antenna 36, a fifth multiplier 11, a receiving antenna 37, an analog receiving circuit 33, analog-to-digital converters 18 and 19, high-pass filters 20 and 21, and an oscillator 27. The control section 31 includes a transmitting circuit 1, a demodulation circuit 22, a DC-carrier-leakage control circuit 23, a shift-frequency-signal generating unit 24, and a frequency multiplier 25 that multiplies a frequency by N. The demodulation circuit 22 includes a low-pass filter 38 and a fast Fourier transformation part 39. The analog transmitting circuit 32 includes low-pass filters 3 and 6, an orthogonal modulation unit 34, a variable amplifier 9 for transmission, and a power amplifier 10 for transmission. The orthogonal modulation unit 34 includes a local oscillator 26, a ninety-degree shifter 7, a first multiplier 4, and a second multiplier 8. The analog receiving circuit 33 includes a low-noise amplifier 12 for reception, a variable amplifier 13 for reception, an orthogonal modulation unit 35, and low-pass filters 16 and 17. The orthogonal modulation unit 35 includes a third multiplier 14 and a fourth multiplier 15.

The control section 31 encodes and modulates and demodulates transmission/reception data. The control section 31 controls the direct current carrier leakage. The analog transmitting circuit 32 up-converts a signal in a baseband into a signal in an RF band. The analog transmitting circuit 32 transmits the outgoing radio signal. The analog receiving circuit 33 down-converts a signal in the RF band into a signal in the baseband. The analog receiving circuit 33 receives the incoming radio signal. The control section 31 detects the amount of direct current carrier leakage on the basis of the In-phase signal and Quadrature-phase signal outputted from the analog receiving circuit 33 when the analog receiving circuit 33 receives the composite signal from the analog transmitting circuit 32. The control section 31 controls the amount of direct current carrier leakage of the outgoing radio signal from the analog transmitting circuit 32 in accordance with the detection of the amount of direct current carrier leakage.

The transmitting circuit 1 generates digital In-phase (I) and Quadrature-phase (Q) signals, and outputs the I and Q signals to the digital-to-analog converters 2 and 5, respectively. The digital-to-analog converter 2 converts the digital I signal into an analog I signal, and outputs differential signals of the I signal. The digital-to-analog converter 5 converts the digital Q signal into an analog Q signal, and outputs differential signals of the Q signal.

The low-pass filter 3 allows only low-frequency elements of the differential signals of the I signal to pass therethrough. The low-pass filter 6 allows only low-frequency elements of the differential signals of the Q signal to pass therethrough. The low-pass filters 3 and 6 remove high-frequency noise that occurs because of intersymbol discontinuity and so forth.

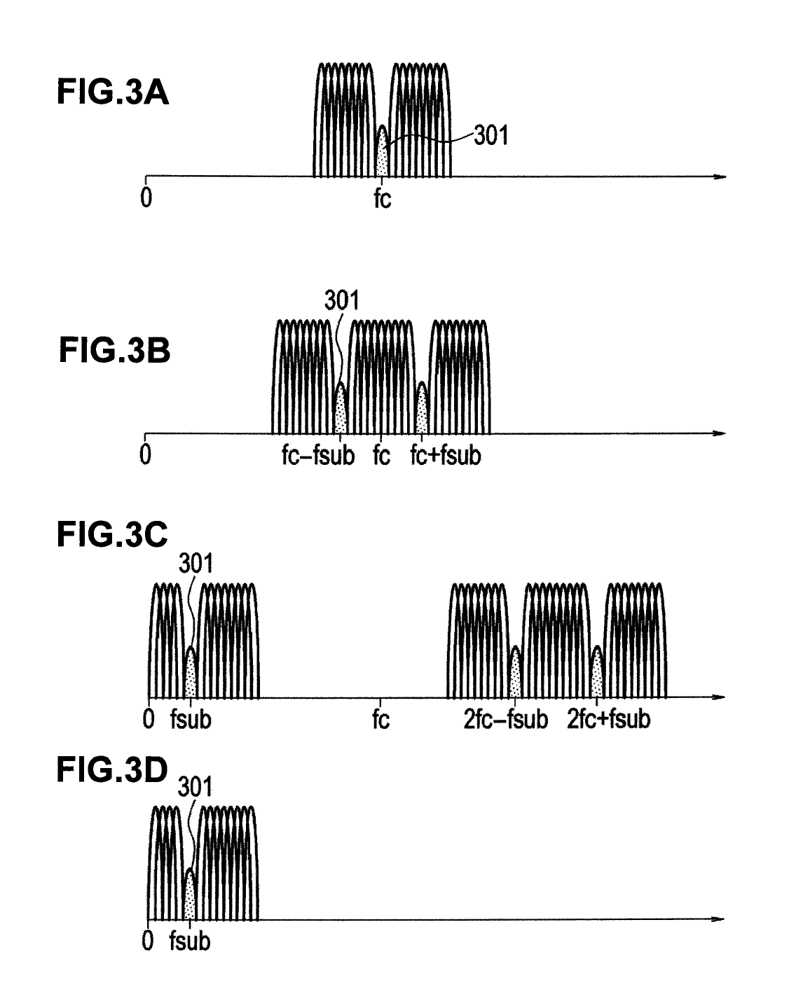

The local oscillator 26 generates a carrier-wave signal having a frequency fc that is indicated by the transmitting circuit 1. The ninety-degree shifter 7 outputs a signal that is obtained by shifting, by 90 degrees, the phase of the carrier-wave signal which is generated by the local oscillator 26. The first multiplier 4 multiplies, by the carrier-wave signal that is generated by the local oscillator 26, the I signal that is output by the low-pass filter 3. The first multiplier 4 multiplies the first carrier-wave signal by the In-phase signal. The second multiplier 8 multiplies, by the signal that is obtained by shifting the phase of the carrier-wave signal with the ninety-degree shifter 7, the Q signal that is output by the low-pass filter 6. The second multiplier 8 multiplies a signal having the similar frequency as and a phase shifted by 90 degree with respect to the first carrier-wave signal by the Quadrature-phase signal. The orthogonal modulation unit 34 performs orthogonal modulation, thereby up-converting the I and Q signals in the baseband into a signal in the RF band. As illustrated in FIG. 3A, the orthogonal modulation unit 34 outputs a transmission signal having a center frequency fc. A DC carrier leakage 301 exists at the center frequency fc.

The variable amplifier 9 amplifies a composite signal of output signals of the first multiplier 4 and the second multiplier 8. The power amplifier 10 amplifies an output of the variable amplifier 9. The transmission signal is controlled by the variable amplifier 9 and the power amplifier 10 so that the transmission signal will have desired power. An output signal of the power amplifier 10 is transmitted as the radio transmission signal via the transmitting antenna 36. The variable amplifier 9 and the power amplifier 10 amplify the composite signal multiplied by the In-phase signal and the Quadrature-phase signal, respectively, and outputting the composite signal for forming the outgoing radio signal.

In this case, the DC carrier leakage 301 is included in the transmission signal because of inconsistency among analog elements that are included in the digital-to-analog converters 2 and 5 and so forth or because of power leakage from the local oscillator 26. For this reason, the fifth multiplier 11 is provided. The fifth multiplier 11 multiplies the output signal of the power amplifier 10 by a signal having a shift frequency fsub, and the multiplied signal is input to the low-noise amplifier 12 in the analog receiving circuit 33. The fifth multiplier 11 multiplies the composite signal from the transmitting circuit 1 by a signal having a shift frequency so as to enable the control section 31 to detect the direct current carrier leakage at the shift frequency. The power amplifier 10 and the low-noise amplifier 12 receive the income radio signal or the composite signal from the transmitting amplifier, and producing an amplified signal. The oscillator 27 generates a signal having a predetermined frequency. The shift-frequency-signal generating unit 24 generates a signal having a sub-carrier frequency spacing f0 using the signal generated by the oscillator 27. The signal having the sub-carrier frequency spacing f0 is input to the frequency multiplier 25. The frequency multiplier 25 outputs, to the fifth multiplier 11, the signal having the shift frequency fsub that is equal to N×f0. The DC-carrier-leakage control circuit 23 may control the value of N (a positive integer) of the frequency multiplier 25. The signal having the shift frequency fsub has a frequency that is N times (an integral multiple of) the sub-carrier frequency spacing f0. As illustrated in FIG. 3B, the fifth multiplier 11 multiplies the transmission signal by the signal having the shift frequency fsub (N×f0), thereby shifting the frequency spectrum of the transmission signal by only ±fsub.

As an input signal, a radio reception signal is input via the receiving antenna 37 to the low-noise amplifier 12, or the transmission signal is input from the fifth multiplier 11 to the low-noise amplifier 12. The low-noise amplifier 12 amplifies the input signal. The variable amplifier 13 amplifies an output signal of the low-noise amplifier 12. The low-noise amplifier 12 and the variable amplifier 13 adjust the input signal so that the input signal will have appropriate power for the orthogonal modulation unit 35.

The third multiplier 14 multiplies, by the carrier-wave signal that is generated by the local oscillator 26, an output signal of the variable amplifier 13, and outputs the multiplied signal as an I signal. The third multiplier 14 produces the In-phase signal by multiplying the second carrier-wave signal by the amplified signal produced by the receiving amplifier. The fourth multiplier 15 multiplies, by the signal that is obtained by shifting the phase of the carrier-wave signal with the ninety-degree shifter 7, the output signal of the variable amplifier 13, and outputs the multiplied signal as a Q signal. The fourth multiplier 15 produces a Quadrature-phase signal by multiplying the signal having the similar frequency as and the phase shifted by 90 degree with respect to the second carrier-wave signal by the amplified signal produced by the receiving amplifier. The orthogonal modulation unit 35 performs orthogonal modulation, thereby down-converting the input signal in the RF band into the I and Q signals in the baseband.

The low-pass filter 16 allows only a low-frequency element of the I signal that is output by the third multiplier 14 to pass therethrough, thereby performing shaping on the I signal. The low-pass filter 17 allows only a low-frequency element of the Q signal that is output by the fourth multiplier 15 to pass therethrough, thereby performing shaping on the Q signal. The analog-to-digital converter 18 converts the analog I signal that is output by the low-pass filter 16 into a digital I signal. The analog-to-digital converter 19 converts the analog Q signal that is output by the low-pass filter 17 into a digital Q signal. The high-pass filter 20 allows only a high-frequency element of the I signal that is output by the analog-to-digital converter 18 to pass therethrough, thereby removing a DC element of the I signal. The high-pass filter 21 allows only a high-frequency element of the Q signal that is output by the analog-to-digital converter 19 to pass therethrough, thereby removing a DC element of the Q signal.

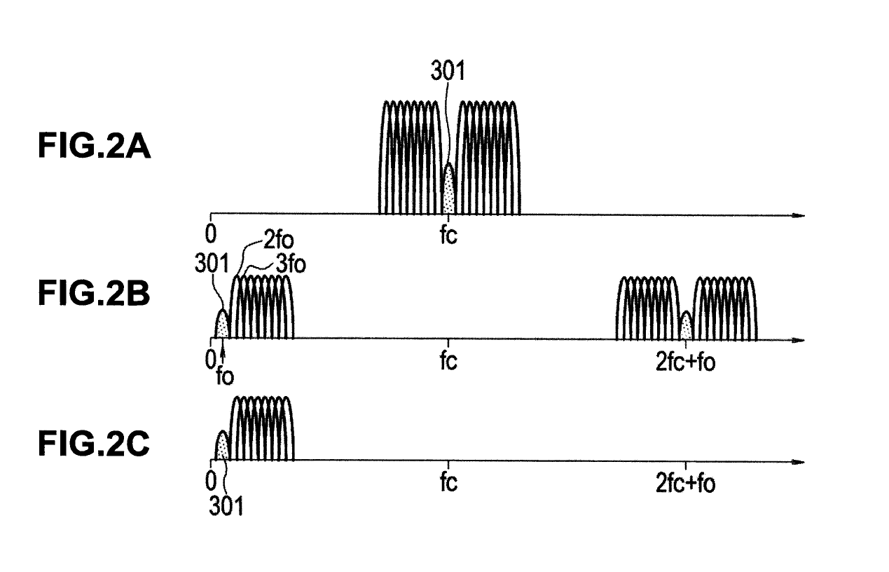

When a reception signal (illustrated in FIG. 2A) is input via the receiving antenna 37 to the analog receiving circuit 33, the orthogonal modulation unit 35 outputs a signal that is obtained by shifting the frequencies of a signal illustrated in FIG. 2B by only f0 to the left. The low-pass filters 16 and 17 output a signal that is obtained by shifting the frequencies of a signal illustrated in FIG. 2C by only f0 to the left. In other words, the DC carrier leakage 301 exists at a frequency of zero. The high-pass filters 20 and 21 may remove the DC carrier leakage 301 included in the reception signal.

Furthermore, when a transmission signal (illustrated in FIG. 3B) is input from the fifth multiplier 11 to the analog receiving circuit 33, the orthogonal modulation unit 35 outputs the signal illustrated in FIG. 3C. The low-pass filters 16 and 17 output the signal illustrated in FIG. 3D. Because the DC carrier leakage 301 exists at the shift frequency fsub (=N×f0), the DC carrier leakage 301 may not be removed by the high-pass filters 20 and 21.

The demodulation circuit 22 includes the low-pass filter 38 and the fast Fourier transformation part 39. The low-pass filter 38 cuts off high-frequency elements of the I and Q signals that are output by the high-pass filters 20 and 21, respectively, and allows only low-frequency elements of the I and Q signals to pass therethrough. The fast Fourier transformation part 39 performs fast Fourier transformation on output signals of the low-pass filter 38, thereby generating frequency spectrums of the I and Q signals. The demodulation circuit 22 controls the cutoff frequency of the low-pass filter 38 on the basis of signals that are obtained by the fast Fourier transformation. For example, on the basis of the frequency spectrums, in a case in which signals having frequencies close to the cutoff frequency are unnecessarily cut off, the demodulation circuit 22 determines that the cutoff frequency is too low, and controls the low-pass filter 38 so that the cutoff frequency will be increased.

The DC-carrier-leakage control circuit 23 detects the amount of the DC carrier leakage 301 illustrated in FIG. 3D from the frequency spectrums of the I and Q signals that are output by the demodulation circuit 22. The DC-carrier-leakage control circuit 23 controls, on the basis of the detected amount of the DC carrier leakage 301, the amount of the DC carrier leakage included in a transmission signal to be transmitted by the analog transmitting circuit 32. Because the transmission signal that is output by the analog transmitting circuit 32 has frequencies that are shifted by only the shift frequency fsub by the fifth multiplier 11, the amount of the DC carrier leakage 301 corresponds to the amplitude of a composite element of elements having the shift frequency fsub in the frequency spectrums of the I and Q signals. The DC-carrier-leakage control circuit 23 detects the amplitude of the element having the shift frequency fsub as the amount of the DC carrier leakage 301, and outputs a signal for reducing the DC carrier leakage to the transmitting circuit 1.

Note that, supposing a case in which the fifth multiplier 11 does not exist, the output signal of the analog transmitting circuit 32 is directly input to the analog receiving circuit 33. In this case, because shifting of the frequencies of the output signal of the analog transmitting circuit 32 by the shift frequency fsub is not performed, the DC carrier leakage 301 exists at a frequency of zero. As in the case of the reception signal, the DC carrier leakage 301 is removed by the high-pass filters 20 and 21, and the amount of the DC carrier leakage 301 may not be detected. In the first embodiment, because the frequencies of the output signal of the analog transmitting circuit 32 are shifted by only the shift frequency fsub by the fifth multiplier 11, the DC carrier leakage 301 may be detected.

FIG. 2A-2C are diagrams illustrating a case in which a transmission signal is down-converted using a frequency that is shifted by f0 from the center frequency fc, and in which the transmission signal is demodulated to obtain a frequency spectrum of the transmission signal in the baseband. Quantitative representations will be described below.

FIG. 2A illustrates a transmission signal that is output by the analog transmitting circuit 32 or a reception signal that is input via the receiving antenna 37 to the analog receiving circuit 33. An OFDM baseband signal s(t) in a carrier-wave band is represented by Formula (1) given below. Here, fc is a center frequency of the carrier-wave signal, f0 is a sub-carrier frequency spacing, and N is the number of subcarriers in a carrier-wave band.

$$\begin{matrix}[ Formula 1 ] & \\ s ( t ) = {\sum }_{n = 0}^{N} [ {a}_{n} cos \{ 2 π ( {f}_{c} + {nf}_{0} ) t \} - {b}_{n} sin \{ 2 π ( {f}_{c} + {nf}_{0} ) t \} ] & ( 1 )\end{matrix}$$

As illustrated in FIG. 2B, when the signal s(t) is down-converted by the third multiplier 14 using a frequency that is shifted by f0 from the center frequency fc of the carrier-wave signal, Formula (2) given below holds.

$$\begin{matrix}[ Formula 2 ] & \\ \begin{matrix}s ( t ) cos \{ 2 π ( {f}_{c} + {f}_{0} ) t \} = {\sum }_{n = 0}^{N} [ \begin{matrix}{a}_{n} cos \{ 2 π ( {f}_{c} + {nf}_{0} ) t \} - \\ {b}_{n} sin \{ 2 π ( {f}_{c} + {nf}_{0} ) t \}\end{matrix} ] \\ cos \{ 2 π ( {f}_{c} + {f}_{0} ) t \} \\ = \frac{1}{2} {\sum }_{n = 0}^{N} [ \begin{matrix}{a}_{n} cos \{ 4 π {f}_{c} t + 2 π ( n + 1 ) {f}_{0} t \} - \\ {b}_{n} sin \{ 4 π {f}_{c} t + 2 π ( n + 1 ) {f}_{0} t \} + \\ {a}_{n} cos \{ 2 π ( n - 1 ) {f}_{0} t \} - \\ {b}_{n} sin \{ 2 {π}_{0} ( n - 1 ) ft \}\end{matrix} ]\end{matrix} & ( 2 )\end{matrix}$$

As illustrated in FIG. 2C, after down-conversion is performed, when a high-frequency element is removed by the low-pass filter 16, a desired baseband I signal I(t) that is represented by Formula (3) given below may be obtained.

$$\begin{matrix}[ Formula 3 ] & \\ I ( t ) = \frac{1}{2} {\sum }_{n = 0}^{N} [ {a}_{n} cos \{ 2 π ( n - 1 ) {f}_{0} t \} - {b}_{n} sin \{ 2 {π}_{0} ( n - 1 ) {f}_{0} t \} ] & ( 3 )\end{matrix}$$

Similarly, regarding a baseband Q signal, when the signal s(t) is down-converted by the fourth multiplier 15, Formula (4) given below holds.

$$\begin{matrix}[ Formula 4 ] & \\ \begin{matrix}s ( t ) [ - sin \{ 2 π ( {f}_{c} + {f}_{0} ) t \} ] = {- \sum }_{n = 0}^{N} [ \begin{matrix}{a}_{n} cos \{ 2 π ( {f}_{c} + {nf}_{0} ) t \} - \\ {b}_{n} sin \{ 2 π ( {f}_{c} + {nf}_{0} ) t \}\end{matrix} ] \\ sin [ \{ 2 π ( {f}_{c} + {f}_{0} ) t \} ] \\ = \frac{1}{2} {\sum }_{n = 0}^{N} [ \begin{matrix}- {a}_{n} sin \{ \begin{matrix}4 π {f}_{c} t + \\ 2 π ( n + 1 ) {f}_{0} t\end{matrix} \} - \\ {b}_{n} cos \{ \begin{matrix}4 π {f}_{c} t + \\ 2 π ( n + 1 ) {f}_{0} t\end{matrix} \} + \\ {a}_{n} sin \{ 2 π ( n - 1 ) {f}_{0} t \} + \\ {b}_{n} cos \{ 2 {π}_{0} ( n - 1 ) {f}_{0} t \}\end{matrix} ]\end{matrix} & ( 4 )\end{matrix}$$

After down-conversion is performed, when a high-frequency element is removed by the low-pass filter 17, a desired baseband Q signal Q(t) that is represented by Formula (5) given below may be obtained.

$$\begin{matrix}[ Formula 5 ] & \\ Q ( t ) = \frac{1}{2} {\sum }_{n = 0}^{N} [ {a}_{n} sin \{ 2 π ( n - 1 ) {f}_{0} t \} + {b}_{n} cos \{ 2 π ( n - 1 ) {f}_{0} t \} ] & ( 5 )\end{matrix}$$

Regarding the above-mentioned I and Q signals, frequencies in the frequency spectrums of the I and Q signals are shifted by f0, compared with frequencies in frequency spectrums in the baseband that may be generated without shifting the frequencies by f0.

The DC carrier leakage 301 corresponds to elements that are obtained by substituting zero into n of Formulas (3) and (5) (the amplitudes of elements having a frequency of f0). Accordingly, the DC carrier leakage 301 includes an I element Idc and a Q element Qdc that are represented by Formula (6) given below.

$$\begin{matrix}[ Formula 6 ] & \\ {I}_{dc} = \frac{1}{2} \{ {a}_{0} cos ( 2 π {f}_{0} t ) + {b}_{0} sin ( 2 π {f}_{0} t ) \} \\ {Q}_{dc} = \frac{1}{2} \{ - {a}_{0} sin ( 2 π {f}_{0} t ) + {b}_{0} cos ( 2 π {f}_{0} t ) \} & ( 6 )\end{matrix}$$

Thus, the DC carrier leakage 301 included in the transmission signal is represented by Formula (7) given below.

$$\begin{matrix}[ Formula 7 ] & \\ \sqrt{{I}_{dc}^{2} + {Q}_{dc}^{2}} = \frac{\sqrt{{a}_{0}^{2} + {b}_{0}^{2}}}{2} & ( 7 )\end{matrix}$$

FIGS. 3A-3D are diagrams illustrating changes in the frequency spectrum of a signal in the communication apparatus illustrated in FIG. 1. FIG. 3A illustrates a frequency spectrum of the transmission signal that is output by the analog transmitting circuit 32 or the reception signal that is input via the receiving antenna 37 to the analog receiving circuit 33. FIG. 3B illustrates a frequency spectrum of the transmission signal having frequencies shifted by the fifth multiplier 11 by only the shift frequency fsub that is an integral multiple of the sub-carrier frequency spacing f0. FIG. 3C illustrates a frequency spectrum of the transmission signal down-converted by the orthogonal modulation unit 35. FIG. 3D illustrates a frequency spectrum of the transmission signal from which high-frequency elements are removed by the low-pass filters 16 and 17. A frequency spectrum of the transmission signal that have been subjected to fast Fourier transformation by the fast Fourier transformation part 39 is similar to the frequency spectrum illustrated in FIG. 3D. In the frequency spectrum illustrated in FIG. 3D, an element having the shift frequency fsub (N×f0) that is an integral multiple of the sub-carrier frequency spacing f0 corresponds to the DC carrier leakage 301 included in the transmission signal. The DC carrier leakage 301 occurs because of offset errors of the baseband I and Q signals or amplitude errors of the I and Q signals.

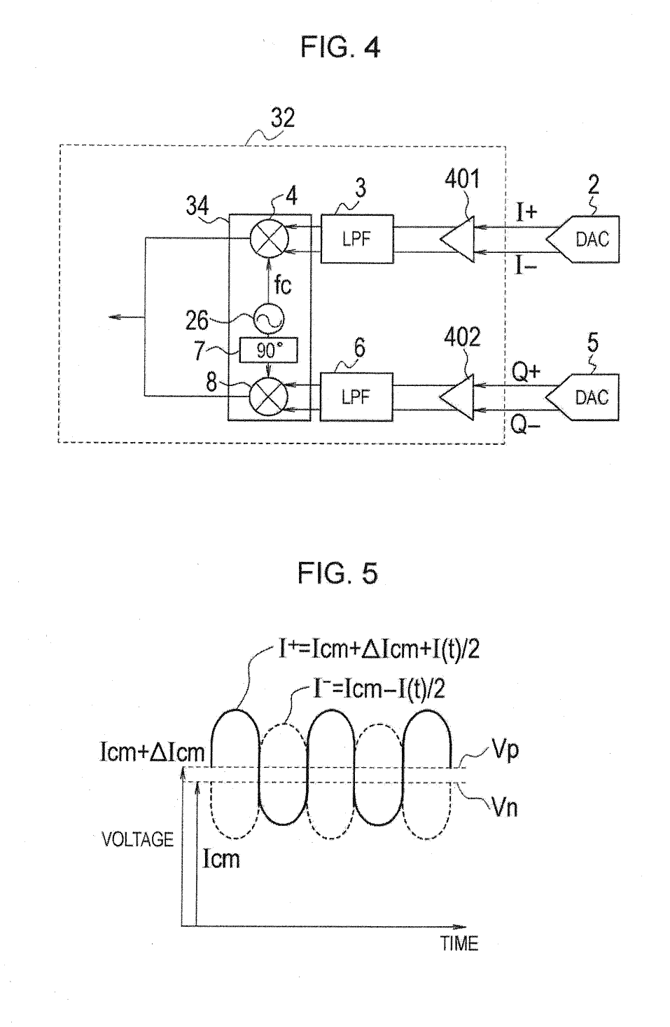

FIG. 4 is a circuit diagram illustrating an example of a detailed configuration of a portion of the analog transmitting circuit 32, and illustrates a function of converting the baseband I and Q signals into the RF transmission signal. The digital-to-analog converter 2 converts the digital I signal into the analog I signal, and outputs the differential signals of the I signal. The digital-to-analog converter 5 converts the digital Q signal into the analog Q signal, and outputs the differential signals of the Q signal. An amplifier 401 amplifies the differential signals of the I signal that are output by the digital-to-analog converter 2. An amplifier 402 amplifies the differential signals of the Q signal that are output by the digital-to-analog converter 5. The low-pass filter 3 allows, to pass therethrough, only the low-frequency elements of the differential signals of the I signal that are output by the amplifier 401. The low-pass filter 6 allows, to pass therethrough, only the low-frequency elements of the differential signals of the Q signal that are output by the amplifier 402. The first multiplier 4 multiplies, by the carrier-wave signal having the center frequency fc that is generated by the local oscillator 26, the differential signals of the I signal that are output by the low-pass filter 3. The second multiplier 8 multiplies, by the output signal of the ninety-degree shifter 7, the differential signals of the Q signal that are output by the low-pass filter 6.

Items that cause occurrence of the DC carrier leakage 301 are mainly mismatching between outputs of the digital-to-analog converters 2 and 5 and inputs to the analog transmitting circuit 32, phase deviations in the first multipliers 4 and 8 that up-convert signals into a signal in the carrier-wave band, power leakage from the local oscillator 26, and so forth. The DC-carrier-leakage control circuit 23 may reduce the amount of the DC carrier leakage by controlling these items.

FIG. 5 is a graph illustrating the relationship between the differential signals I+ and I− of the baseband I signal and DC offsets Vp and Vn. The differential signals I+ and I− of the I signal are signals having signs that are opposite to each other. The DC offset Vp is a DC offset of the differential signal I+ of the I signal. The DC offset Vn is a DC offset of the differential signal I− of the I signal. It is desirable that the DC offset Vp be equal to the DC offset Vn. Occurrence of the DC carrier leakage 301 is caused by the deviation between the DC offsets Vp and Vn. For example, the DC offset Vn is a voltage Icm, and the DC offset Vp is a voltage Icm+ΔIcm. The control section 31 controls either of the DC offsets Vp and Vn of the differential analog signals that are obtained by conversion performed by the digital-to-analog converter 2 or 5 or the like, whereby the control section 31 may control the amount of the DC carrier leakage 301.

Occurrence of the DC carrier leakage 301 that is caused by DC offset errors ΔIcm and ΔQcm of the baseband I and Q signals, respectively, will be simply described below. The differential signals I+, I−, Q+, and Q− of the baseband I and Q signals are represented by Formula (8) given below. Here, ΔIcm is a DC offset error between the differential signals I+ and I− of the baseband I signal, and ΔQcm is a DC offset error between the differential signals Q+ and Q− of the baseband Q signal. The signals I(t) and Q(t) are baseband signals, and are represented by Formulas (3) and (5) given above, respectively.

[Formula 8]

I⁺=I_{cm}+ΔI_{cm}+I(t)/2

I⁻=I_{cm}−I(t)/2

Q⁺=Q_{cm}+ΔQ_{cm}+Q(t)/2

Q⁻=Q_{cm}−Q(t)/2 (8)

Accordingly, the baseband I and Q signals including the DC carrier leakage are represented by Formula (9) given below.

[Formula 9]

I=I⁺−I⁻=ΔI_{cm}+I(t)

Q=Q⁺−Q⁻=ΔQ_{cm}+Q(t) (9)

The I and Q signals are up-converted into the transmission signal in the RF band by the orthogonal modulation unit 34. The transmission signal in the RF band is represented by Formula (10) given below.

$$\begin{matrix}[ Formula 10 ] & \\ ( I + j Q ) {e}_{t}^{j2π {f}_{c}^{t}} = \frac{1}{2} {\sum }_{n = 0}^{N} ( {a}_{n} + {jb}_{n} ) {e}^{j2π ( n - 1 ) {f}_{0}^{t}} {e}^{j2π {f}_{c}^{t}} + ( Δ {I}_{CM} + jΔ {Q}_{CM} ) {e}^{j2π {f}_{c}^{t}} & ( 10 )\end{matrix}$$

The first term of the right-hand side of Formula (10) represents a baseband signal in the carrier-wave band. The second term of the right-hand side represents the DC carrier leakage 301 that is caused by the DC offsets of the baseband I and Q signals. As is clear from Formula (10), in order to reduce the DC carrier leakage 301, each of the DC offset errors ΔIcm and ΔQcm of the baseband I and Q signals needs to be reduced to a minimum.

Accordingly, the control section 31 detects the DC carrier leakage 301 included in the transmission signal to obtain a result. The control section 31 feeds the result back to voltage control units for the DC offsets Icm and Qcm that are included in the digital-to-analog converters 2 and 5 to reduce the DC offset errors ΔIcm and ΔQcm of the baseband I and Q signals, whereby the DC carrier leakage 301 included in the transmission signal may be reduced.

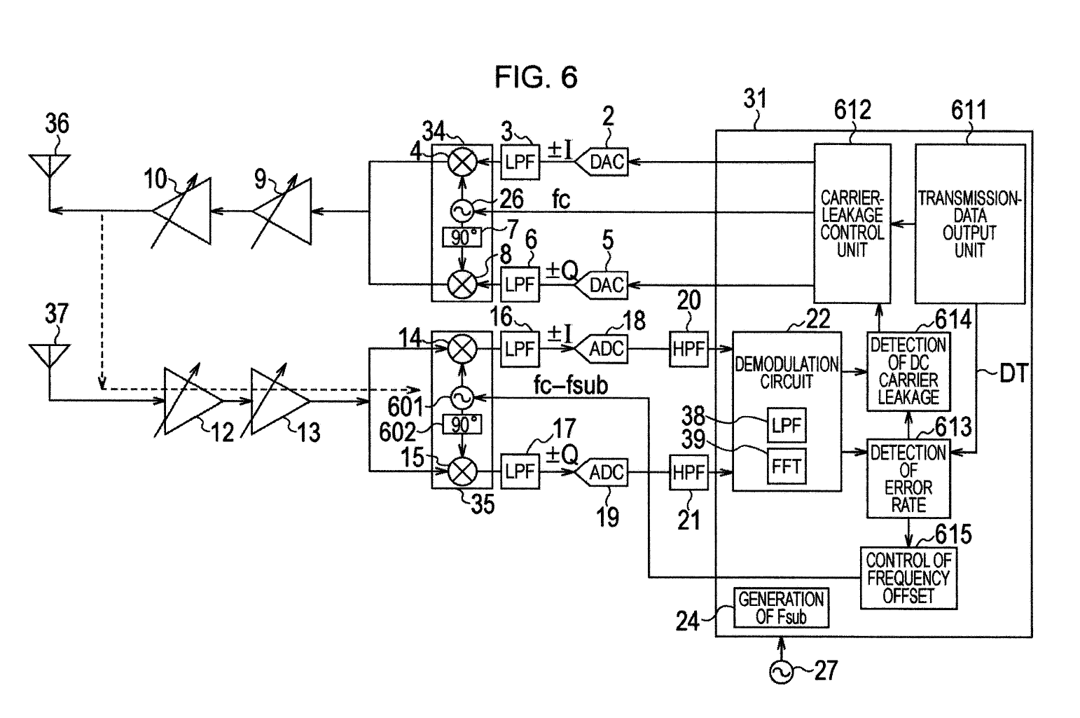

FIG. 6 is a diagram illustrating an example of a configuration of a communication apparatus according to a second embodiment. The communication apparatus illustrated in FIG. 6 is obtained by removing the transmitting circuit 1, the fifth multiplier 11, the DC-carrier-leakage control circuit 23, and the frequency multiplier 25 from the communication apparatus illustrated in FIG. 1, and by adding a local oscillator 601, a ninety-degree shifter 602, a transmission-data output unit 611, a carrier-leakage control unit 612, an error-rate detection unit 613, a DC-carrier-leakage detection unit 614, and a frequency-offset control unit 615. Hereinafter, the differences between the first embodiment and the second embodiment will be described.

A transmission signal that is output by the power amplifier 10 is directly input to the low-noise amplifier 12. In this case, the frequency-offset control unit 615 instructs the local oscillator 601 to oscillate a signal having a local oscillation frequency fc-fsub using the signal having the shift frequency fsub that is generated by the shift-frequency-signal generating unit 24. The frequency fc is a frequency of the carrier-wave signal (hereinafter, referred to as a “carrier-wave frequency”) generated by the local oscillator 26. The local oscillator 601 generates a carrier-wave signal having the local oscillation frequency fc-fsub. The ninety-degree shifter 602 shifts, by 90 degrees, the phase of the carrier-wave signal that is generated by the local oscillator 601. The third multiplier 14 multiplies an output signal of the variable amplifier 13 by the carrier-wave signal that is generated by the local oscillator 601, and outputs the multiplied signal as an I signal having frequencies that are shifted by only the shift frequency fsub as illustrated in FIG. 3C. The fourth multiplier 15 multiplies the output signal of the variable amplifier 13 by a signal that is obtained by shifting, with the ninety-degree shifter 602, the phase of the carrier-wave signal generated by the local oscillator 601. The fourth multiplier 15 outputs the multiplied signal as a Q signal having frequencies that are shifted by only the shift frequency fsub as illustrated in FIG. 3C. A process similar to the process performed in the first embodiment may be performed as the subsequent process.

Furthermore, a reception signal is input via the receiving antenna 37 to the low-noise amplifier 12. In this case, the frequency-offset control unit 615 instructs the local oscillator 601 to oscillate a signal having the carrier-wave frequency fc using the signal that is generated by the oscillator 27. The local oscillator 601 generates a carrier-wave signal having the carrier-wave frequency fc. The ninety-degree shifter 602 shifts, by 90 degrees, the phase of the carrier-wave signal that is generated by the local oscillator 601. The third multiplier 14 multiplies an output signal of the variable amplifier 13 by the carrier-wave signal that is generated by the local oscillator 601. The third multiplier 14 outputs the multiplied signal as an I signal having frequencies that are not shifted by the shift frequency fsub. The fourth multiplier 15 multiplies the output signal of the variable amplifier 13 by a signal that is obtained by shifting, with the ninety-degree shifter 602, the phase of carrier-wave signal generated by the local oscillator 601. The fourth multiplier 15 outputs the multiplied signal as a Q signal having frequencies that are not shifted by the shift frequency fsub. In other words, the third multiplier 14 and the fourth multiplier 15 output a signal that is obtained by shifting the frequencies of the signal illustrated in FIG. 3C by only the shift frequency fsub to the left. A process in this case is the similar to the process performed in the first embodiment.

As in the first embodiment, the DC-carrier-leakage detection unit 614 detects the amount of the DC carrier leakage 301 using output signals of the demodulation circuit 22. As in the first embodiment, the carrier-leakage control unit 612 controls, on the basis of the amount of the DC carrier leakage 301 detected by the DC-carrier-leakage detection unit 614, the amount of the DC carrier leakage 301 included in a transmission signal that is to be transmitted by the analog transmitting circuit 32.

The transmission-data output unit 611 outputs, via the carrier-leakage control unit 612 to the digital-to-analog converters 2 and 5, digital I and Q signals for generating a transmission signal to be transmitted, respectively.

The analog transmitting circuit 32 generates a transmission signal using the I and Q signals that are output by the transmission-data output unit 611. The transmission signal is input to the analog receiving circuit 33, and demodulated by the demodulation circuit 22. The error-rate detection unit 613 detects a DT of the I and Q signals that are output by the transmission-data output unit 611 and an error rate between the I and Q signals that are demodulated by the demodulation circuit 22. When the DC carrier leakage 301 does not exist, the error rate becomes zero. In contrast, when the amount of the DC carrier leakage 301 is large, the error rate becomes high. As in the first embodiment, the carrier-leakage control unit 612 controls, on the basis of the amount of the DC carrier leakage 301 detected by the DC-carrier-leakage detection unit 614 and on the basis of the error rate detected by the error-rate detection unit 613, the amount of the DC carrier leakage 301 included in a transmission signal that is to be transmitted by the analog transmitting circuit 32.

In the first embodiment, the frequencies of the transmission signal are shifted by only the shift frequency fsub. In contrast, in the second embodiment, in the analog receiving circuit 33, the transmission signal is down-converted using the local oscillation frequency fc-fsub that is shifted by only the shift frequency fsub (=N×f0) from the carrier-wave frequency fc.

As described above, according to the first and second embodiments, when down-conversion of a transmission signal into a signal having frequencies in the baseband is performed, the transmission signal is down-converted using a frequency that is shifted by only the shift frequency fsub from the center frequency fc of the transmission signal, thereby shifting the frequency spectrum of the transmission signal in the baseband by only the shift frequency fsub. With this down-conversion, the DC carrier leakage 301 may be demodulated, by the demodulation circuit 22 in the control section 31, as a value of the amplitude of an element having the shift frequency fsub in the frequency spectrum in the baseband. Accordingly, the DC carrier leakage 301 is not removed by the analog receiving circuit 33. Thus, the control section 31 may detect the amount of the DC carrier leakage 301 included in the transmission signal when the communication apparatus operates.

Each of the first and second embodiments may be implemented by causing the analog receiving circuit 33, in a transmission time, to shift the frequencies of a signal by only the shift frequency fsub and to perform a reception operation. Thus, the first and second embodiments significantly contribute to reduction in product cost. Furthermore, because each of the first and second embodiments may be implemented when the communication apparatus operates, maintenance of the communication apparatus that needs to continuously operate is facilitated. In other words, the first and second embodiments may significantly contribute to improvement in quality and reduction in cost.

Additionally, in the first and second embodiments, a reception signal is down-converted using a frequency that is only the half of an occupied bandwidth distant from the center frequency (the carrier-wave frequency) fc. Accordingly, the DC carrier leakage 301 included in the reception signal may be removed by the analog receiving circuit 33. This significantly contributes to reduction of a carrier-leakage removal function (the high-pass filters 20 and 21) that the analog receiving circuit 33 has.

Each of the communication apparatuses according to the first and second embodiments includes the analog transmitting circuit 32 that transmits a radio signal, the analog receiving circuit 33 that receives a radio signal, and the control section 31 that controls the amount of the DC carrier leakage. The analog transmitting circuit 32 includes the first multiplier 4, the second multiplier 8, the variable amplifier 9, and the power amplifier 10. The first multiplier 4 multiplies an I signal by a first carrier-wave signal. The second multiplier 8 multiplies a Q signal by a signal that is obtained by shifting the phase of the first carrier-wave signal by 90 degrees. The variable amplifier 9 and the power amplifier 10 amplify the composite signal of the output signals of the first multiplier 4 and the second multiplier 8, and output the amplified signal. The output signal of the analog transmitting circuit 32 or a reception signal is input to the analog receiving circuit 33. The analog receiving circuit 33 includes the low-noise amplifier 12, the variable amplifier 13, the third multiplier 14, and the fourth multiplier 15. The low-noise amplifier 12 and the variable amplifier 13 amplify the signal that is input to the analog receiving circuit 33. The third multiplier 14 multiplies, by a second carrier-wave signal, the signal that is amplified by the low-noise amplifier 12 and the variable amplifier 13, and outputs the multiplied signal as an I signal. The fourth multiplier 15 multiplies, by a signal that is obtained by shifting the phase of the second carrier-wave signal by 90 degrees, the signal that is amplified by the low-noise amplifier 12 and the variable amplifier 13, and outputs the multiplied signal as a Q signal. In the first embodiment, the first carrier-wave signal and the second carrier-wave signal are the similar signal. In the second embodiments, the first carrier-wave signal and the second carrier-wave signal are different signals. In a case in which the output signal of the analog transmitting circuit 32 is input to the analog receiving circuit 33, the analog receiving circuit 33 outputs the I and Q signals having shifted frequencies, compared with a case in which the reception signal is input to the analog receiving circuit 33. In the case in which the output signal of the analog transmitting circuit 32 is input to the analog receiving circuit 33, the control section 31 detects the amount of the DC carrier leakage using the I and Q signals that are output from the analog receiving circuit 33. The control section 31 controls, on the basis of the detected amount of the DC carrier leakage, the amount of the DC carrier leakage included in a transmission signal that is to be transmitted by the analog transmitting circuit 32.

The digital-to-analog converters 2 and 5 convert the digital I and Q signals into the analog I and Q signals, and output the analog I and Q signals to the analog transmitting circuit 32. The control section 31 controls the DC offsets of the analog I and Q signals that are obtained by conversion performed by the digital-to-analog converters 2 and 5, thereby controlling the amount of the DC carrier leakage.

The high-pass filters 20 and 21 remove the DC carrier leakage 301 included in the I and Q signals that are output when the reception signal is input to the analog receiving circuit 33. The high-pass filters 20 and 21 output the I and Q signals to the control section 31.

The control section 31 includes the fast Fourier transformation part 39 that performs fast Fourier transformation on the I and Q signals, and detects, using the signals that are obtained by fast Fourier transformation, the amount of the DC carrier leakage.

Furthermore, the control section 31 includes the low-pass filter 38 that allows only the low-frequency elements of the I and Q signals to pass therethrough, and the fast Fourier transformation part 39 that performs fast Fourier transformation on the output signals of the low-pass filter 38. The control section 31 controls the cutoff frequency of the low-pass filter 38 on the basis of the signals that are obtained by the fast Fourier transformation.

In the first embodiment, the fifth multiplier 11 multiplies, by the signal having the shift frequency fsub that is a frequency shift amount, the output signal of the analog transmitting circuit 32. The multiplied signal is input to the analog receiving circuit 33. In this case, the first carrier-wave signal and the second carrier-wave signal are the similar signal.

In the second embodiment, in the case in which the reception signal is input to the analog receiving circuit 33, the frequency of the second carrier-wave signal is the similar to that of the first carrier-wave signal. Furthermore, in the case in which the output signal of the analog transmitting circuit 32 is input to the analog receiving circuit 33, the frequency of the second carrier-wave signal is different from that of the first carrier-wave signal.

In the second embodiment, the control section 31 detects an error rate between the I and Q signals for generating a transmission signal to be transmitted by the analog transmitting circuit 32 and the I and Q signals that are output by the analog receiving circuit 33 when the output signal of the analog transmitting circuit 32 is input to the analog receiving circuit 33. The control section 31 controls, on the basis of the detected amount of the DC carrier leakage and on the basis of the detected error rate, the amount of the DC carrier leakage included in the transmission signal that is to be transmitted by the analog transmitting circuit 32.

As described above, in the first and second embodiments, in the case in which the output signal of the analog transmitting circuit 32 is input to the analog receiving circuit 33, the analog receiving circuit 33 outputs the I and Q signals having shifted frequencies. Thus, the amount of the DC carrier leakage included in the output signal of the analog transmitting circuit 32 may be detected, and the amount of the DC carrier leakage may be reduced.

The high-pass filters 20 and 21 may remove the DC carrier leakage. However, in some cases, the high-pass filters 20 and 21 may not completely remove the DC carrier leakage. That is, a portion of the DC carrier leakage remains, and the high-pass filters 20 and 21 output the DC carrier leakage excluding the remaining portion. When the amount of the remaining portion of the DC carrier leakage is large, the demodulation circuit 22 may not perform accurate demodulation, so that the values of the I and Q signals are erroneously demodulated. In the first and second embodiments, erroneous demodulation may be prevented by reducing the DC carrier leakage included in the transmission signal.

Note that any of the above-described embodiments is merely a specific example for implementing the present invention. It should be understood that the embodiments are not to be construed as limiting the technical scope of the present invention. In other words, the present invention may be implemented in a variety of forms without departing from the technical concept or principal features thereof.

All examples and conditional language recited herein are intended for pedagogical purposes to aid the reader in understanding the embodiment and the concepts contributed by the inventor to furthering the art, and are to be construed as being without limitation to such specifically recited examples and conditions, nor does the organization of such examples in the specification relate to a illustrating of the superiority and inferiority of the embodiment. Although the embodiments of the present invention have been described in detail, it should be understood that the various changes, substitutions, and alterations could be made hereto without departing from the spirit and scope of the invention.

What is claimed is:

1. A communication apparatus comprising:
a transmitter for transmitting an outgoing radio signal;
a receiver for receiving an incoming radio signal; and
a controller for controlling a direct current carrier leakage;
wherein the transmitter includes:
a first multiplier for multiplying a first carrier-wave signal by an In-phase signal;
a second multiplier for multiplying a signal having the similar frequency as and a phase shifted by 90 degree with respect to the first carrier-wave signal by a Quadrature-phase signal; and
a transmitting amplifier for amplifying a composite signal multiplied by the In-phase signal and the Quadrature-phase signal, respectively, and outputting the composite signal for forming the outgoing radio signal;
wherein the receiver includes:
a receiving amplifier for receiving the income radio signal or the composite signal from the transmitting amplifier, and producing an amplified signal;
a third multiplier for producing an In-phase signal by multiplying a second carrier-wave signal by the amplified signal produced by the receiving amplifier; and
a fourth multiplier for producing a Quadrature-phase signal by multiplying a signal having the similar frequency as and a phase shifted by 90 degree with respect to the second carrier-wave signal by the amplified signal produced by the receiving amplifier;
wherein the controller detects an amount of direct current carrier leakage on a basis of the In-phase signal and Quadrature-phase signal outputted from the receiver when the receiver receives the composite signal from the transmitter, and controls the amount of direct current carrier leakage of the outgoing radio signal from the transmitter in accordance with the detection of the amount of direct current carrier leakage.

2. The communication apparatus according to claim 1, further comprising a fifth multiplier for multiplying the composite signal from the transmitter by a signal having a shift frequency so as to enable the controller to detect the direct current carrier leakage at the shift frequency; and
wherein the similar carrier-wave signal is used as the first and the second carrier-wave signals.

3. The communication apparatus according to claim 1, wherein the second frequency of the carrier-wave signal is the similar to the first frequency of the carrier-wave signal when the receiver receives the receiving signal, and the second frequency of the carrier-wave signal is different from the first frequency of the carrier-wave signal when the receiver receives the outputting signal from the transmitter.

4. The communication apparatus according to claim 1, wherein the controller detects an error rate between the In-phase and Quadrature-phase signal to be transmitted by the transmitter and the In-phase and Quadrature-phase signal produced by the receiver when the controller receives the outputted radio signal from the transmitter, and controls the amount of direct current carrier leakage of the outgoing radio signal from the transmitter in accordance with the amount of direct current carrier leakage and the error rate detected by the controller.

5. The communication apparatus according to claim 1, further comprising a digital-to-analog converter converting a digital In-phase signal to an analog In-phase signal, a digital Quadrature-phase signal to an analog Quadrature-phase signal, and outputting the analog In-phase and Quadrature-phase signals to the transmitter, and
wherein the controller controls the amount of direct current carrier leakage of the signal from the transmitter by controlling a direct current offset on the analog In-phase and Quadrature-phase signals converted by the digital to analog converter.

6. The method according to claim 1, further comprising a filter removing the direct current carrier leakage of In-phase and Quadrature-phase signals produced by the receiver when the receiver receives the incoming radio signal or the composite signal, and outputting the In-phase and Quadrature-phase signals to the controller after removing the direct current carrier leakage of In-phase and Quadrature-phase signals.

7. The communication apparatus according to claim 1, wherein the controller includes a Fourier transformer for performing Fourier transformation on the In-phase and Quadrature-phase signal, and the controller detects the amount of direct current carrier leakage in accordance with the Fourier transformation on the In-phase and Quadrature-phase signal.

8. The communication apparatus according to claim 1, wherein the controller includes a low-pass filter for passing a low-frequency element of the In-phase signal and Quadrature-phase signal, and a Fourier transformer for performing Fourier transformation on the In-phase and Quadrature-phase signal being passed through the low-pass filter, and the controller controls a cutoff frequency of the low-pass filter in accordance with the Fourier transformation on the In-phase and Quadrature-phase signal.
